(19) United States
(12) Patent Application Publication
(10) Pub. No.: US 2026/0298717 A1
(43) Pub. Date: Oct. 1, 2026

(54) AUTOMATED PYROMETER TRACKING

(71) Applicant: Heraeus Covantics North America LLC, Chandler, AZ (US)

(72) Inventors: Luke WALKER, Chandler, AZ (US); Austin SUDER, Chandler, AZ (US)

(21) Appl. No.: 19/480,961

(22) PCT Filed: May 1, 2024
(86) PCT No.: PCT/US2024/027159

§ 371 Date: Nov. 3, 2025

Related U.S. Application Data
(60) Provisional application No. 63/464,866, filed on May 8, 2023.

(51) Int. Cl. G01J 5/02; G01J 5/00; G01J 5/04

(52) U.S. Cl. CPC G01J 5/0275; G01J 5/0007; G01J 5/047

(57) ABSTRACT

Components, systems, assemblies, and methods related thereto for automatic alignment of a temperature measurement device with a die cavity in a sintering process are described. These include monitoring temperature of a location on a die, and include a pyrometer, laser measuring devices mounted to the pyrometer, and projecting a laser beam and measuring distance from the laser measuring device to a location on which the laser beam is projected. Each laser device outputs a signal and an actuator adjusts the pyrometer position in accordance with these signals.

### TECHNICAL FIELD

The present invention relates to methods and systems for spark plasma sintering, also known as direct current sintering, in which a temperature measurement device is used to monitor temperature of a particular location on a die that experiences a motion, such as vertical, horizontal or a combination thereof, during processing.

### BACKGROUND

Spark plasma sintering (“SPS”), also referred to as direct current sintering (“DCS”) and field assisted sintering technique (“FAST”), is a pressure assisted sintering technology capable of processing conductive and nonconductive materials. SPS/DCS provide for more rapid densification and material property enhancement, the mechanisms of which are still under investigation. However, the most commonly accepted mechanisms are faster heating rates, joule heating and possible electric field influence on densification.

During a typical SPS/DCS process, either an ON-OFF, commonly square wave DC pulse or a continuous direct current is applied to a powder contained within a punch and die type tooling set, typically composed of graphite but not to exclude metal, ceramic or a composite, to generate joule heat and contain the pressure. Graphite is the most common material because it is a good electrical conductor and is stable to extremely high temperatures. The abbreviation DCS is sometimes used to indicate a system that provides an unpulsed direct current to the die. However, SPS and DCS are frequently used to mean the same type of apparatus and are used herein interchangeably. In a SPS/DCS apparatus, the heat is transferred to the powder by heat conduction from the die, and, if the powder is electrically conductive, electrical current can flow through the powder directly generating joule heat within material being sintered.

Operation or monitored temperatures in an SPS apparatus range from 200° C. to 2400° C. Material processing (pressure and temperature rise and hold time) is typically completed in an SPS apparatus in shorter periods compared to prior technologies. The faster processing times provide for greater control over grain growth and microstructure enhancing material properties directly related to microstructure such as strength, toughness, electrical properties, thermal properties, optical properties and corrosion and erosion resistance.

Temperature during sintering is typically monitored using either a thermocouple or a pyrometer positioned within range of the die. Due to the electrical field present in the tooling a thermocouple is less preferred due to their sensitivity to stray voltage. In order to ensure optimal sintering conditions, it is important to identify a consistent control point and monitor the temperature of that position throughout the process. However, during sintering, compaction and densification of the powder occurs, leading to a need for dynamic positioning of the pyrometer as the sintered product is formed. More particularly, the reason the pyrometer must move is the die case itself moves during the compaction and densification. Repositioning of the pyrometer relative to the die is typically done manually, which is often difficult to do consistently and in a timely manner, as the optimum position changes over the sintering time. Inaccuracies produce variability in product quality, especially from run to run.

Components and methods for automatic pyrometer tracking in sintering are known, such as are found in the following background patents, patent publications and non-patent literature (if any), which are found in the appendices and incorporated by reference in their entireties, are disclosed merely for background purposes and relevant to the state of the art, but do not contain one or more of the elements of the present invention: for example, in US Patent Publication No. 2016/0325353 and U.S. Pat. No. 4,936,765 and are found in the appendices.

Indeed, a basic block diagram of a typical SPS/DCS apparatus can be found in US Patent Publication No. 2016/0325353 (see appendix), including the SPS/DCS system of the present invention. As shown in FIG. 1 of US Patent Publication No. 2016/0325353, sintering apparatus 100 includes a vacuum chamber 102 located within load frame 104 and further includes an observation window 106 and temperature measurement device 108, both of which are incorporated into the vacuum chamber 102. The material to be sintered (typically a powder material), is loaded into die set 111 and is placed within vacuum chamber 102 of sintering apparatus 100 wherein the process is performed. More specifically, as shown, die set 111 includes casing 112 and two opposing rams, lower ram 120 and upper ram 122, forming die cavity 110 in which the material to be sintered is placed. Sintering apparatus 100 further includes hydraulic power unit 116 and hydraulic press cylinder 118. The hydraulic power unit provides power to the hydraulic press cylinder, which in turn is used to move the lower ram and the upper ram up and down to manipulate the mechanical force (or pressure) applied, thereby compressing the sinterable material during the process. The force may be measured and monitored, such as with a load cell. In addition, a DC power supply 114 provides the necessary electrical current within vacuum chamber 102 during the compression. As shown, sintering apparatus 100 also includes vacuum pump 124, which allows the apparatus to operate under negative atmospheric pressure. Gas 126 can also be injected into vacuum chamber 102 if desired during the process. Central control system 128 can be used to control the different aspects of the sintering apparatus during use. For example, the control system can be used to control the DC power supply, the hydraulic power unit, the vacuum pump, as well as to control the amount of any inert gas introduced to the vacuum chamber during use.

Additionally, as shown in FIG. 2 of US Patent Publication No. 2016/0325353 (see appendix), a die set 211 comprises casing 212 and two opposing rams, lower ram 220 and upper ram 222, forming a die cavity in which the material to be sintered 205 (powder) is placed. As shown, the die cavity is vertically symmetrical, although other shapes are possible. A target location of the die cavity is identified, which, in this example, is the geometric centerline of the material. Assuming constant density throughout the sample, especially vertically, and heating, this would be the position of highest measurable temperature relative to the powder. As can be seen in FIG. 2 of US Patent Publication No. 2016/0325353 (see appendix), as the powder is sintered to form the desired sintered part 295, the position of the centerline changes.

The prior art does not disclose a method or system with enough accuracy to provide for unattended tracking of a pyrometer hole or recess in a die of a field assisted sintering device.

Thus, while spark plasma methods and systems are known, there is a need to provide for sintering systems and methods that improve process consistency both during and between cycles.

### SUMMARY

To meet these and other needs, and in view of its purposes, the disclosure relates to components and methods related thereto for alignment of a temperature measurement device with a die cavity in a sintering process.

In one aspect, the disclosure describes a system for monitoring temperature of a location on a die. The system includes a pyrometer having an end, the pyrometer being configured to measure temperature based upon intensity of thermal radiation received at the end of the pyrometer, and the pyrometer having opposite sides.

The system also includes first and second laser measuring devices mounted to the pyrometer, one of the laser measuring devices being mounted proximate one side of the pyrometer, and the other laser measuring device being mounted proximate the opposite side of the pyrometer, each laser measuring device projecting a laser beam and measuring distance from the laser measuring device to a location on which the laser beam is projected, each laser measuring device outputting a signal indicating whether the measured distance is less than or equal to a minimum distance. The system includes an actuator connected in communication with each laser measuring device and receiving the signal output from each laser measuring device, the actuator supporting the pyrometer and moving the pyrometer in first and second directions opposite one another in accordance with the signals received from the laser measuring devices until each received signal indicates the measured distance is not less than or equal to the minimum distance.

When each received signal indicates the measured distance is greater than the minimum distance, the end of the pyrometer is positioned opposite the location on the die for receiving thermal radiation therefrom and outputting a temperature signal based on the intensity of the thermal radiation.

The pyrometer includes a top and a bottom with one of the laser measuring devices mounted proximate the top of the pyrometer and the other laser measuring device is mounted proximate the bottom of the die, and the actuator moves the pyrometer up and down. When the actuator receives a signal from one of the laser measuring devices, the actuator moves the pyrometer downward, and when the actuator receives a signal from said other laser measuring device, the actuator moves the pyrometer upward. However, if the system receives a signal from both the laser measuring devices, the actuator does not adjust the position of the pyrometer.

The die includes a height, and the actuator moves the pyrometer parallel to the height of the die. In another aspect, the laser measuring devices are aligned vertically along the height of the die. In a further aspect, each laser measuring device is mounted an equal distance from the die in which the distance is measured from a point on the outer sidewall of the die closest to the laser measuring device. Further, the actuator is programmable.

In another aspect, the disclosure describes a method of tracking a recess in a die using a temperature measurement device. The method includes mounting oppositely a first laser and a second laser to a temperature measurement device to create a pyrometer assembly; aligning the temperature measurement device with the recess using the first laser to project a laser beam into the recess to measure a first laser beam distance and project the second laser beam into the recess to measure a second laser beam distance; and realigning the temperature measurement device with the recess by moving the pyrometer assembly when a reduction of the first laser beam distance or the second laser beam distance is detected so that the first laser beam and the second laser beam are projected into the recess.

The die includes a height, and the step of mounting includes mounting the first laser and second laser oppositely along the height of the die. When a reduction of the first laser beam distance is detected, the pyrometer assembly is moved in a first direction, and when a reduction of the second laser beam distance is detected, the pyrometer assembly is moved in a second direction opposite the first direction.

Each laser is integrated with a laser measurement device, which detects when there is a reduction in laser beam distance and provides a signal. The method of further includes mounting the pyrometer assembly to an actuator receiving the signals with the actuator, and performing the step of realigning by using the actuator to move the pyrometer assembly in accordance with the signal received.

The method additionally includes mounting the pyrometer assembly to an actuator and using the actuator to perform the steps of aligning and realigning. The step of mounting includes mounting the lasers equally distant from a point on the die nearest each laser.

In yet another aspect, the disclosure describes a method of forming a sintered product comprising, in any order, the steps: i) loading a material to be sintered into a die cavity of a die set comprising a casing and opposing rams configured to compress the material; ii) placing the die set into a vacuum chamber of a sintering apparatus, the sintering apparatus comprising a temperature measurement device configured to determine the temperature of material in the die cavity during sintering and a control system configured to move the temperature measurement device during sintering; iii) positioning the temperature measurement device relative to a target location of the die cavity using a first laser and a second laser to a temperature measurement device to create a pyrometer assembly, aligning the temperature measurement device with the die cavity using the first laser to project a laser beam into the die cavity to create a first laser beam distance and the second laser beam to project into the die cavity to create a second laser beam distance, realigning the temperature measurement device with die cavity automatically by moving the pyrometer assembly when a reduction of the first laser beam distance or the second laser beam distance is detected so that the first laser beam and the second laser beam are projected into the die cavity, and iv) compressively sintering the material in the die cavity to form the sintered product, wherein, during the compressive sintering, the temperature measurement device is moved in order to maintain the relative positioning to the target location of the die cavity using the control system.

In a more detailed aspect of the foregoing method, the sintering apparatus further comprises a repositioning device in communication with the temperature measurement device and the control system, and wherein the temperature measurement device is moved by the repositioning device using the control system. In yet more detail of the method, the die set includes an outer casing, an upper ram, and a lower ram, and the step of moving the temperature measurement device includes determining a position of the upper ram, the lower ram, or both. In yet further detail, the temperature measurement device is moved continuously during the compressive sintering. In more detail, moving the temperature measurement device is automated, and the sintering apparatus is a spark plasma sintering apparatus or a direct current sintering apparatus.

In another aspect, the disclosure describes a control system for automatic pyrometer tracking comprising a die with a die cavity having a temperature measurement device opening having a first edge portion and a second edge portion with a target depth, a first laser having a first laser beam, a second laser having a second laser beam, a temperature measurement device for observing a temperature of the die through the temperature measurement device opening, and at least one sensor to measure a first laser beam distance to the target depth and a second laser beam distance to the target depth, and wherein the first laser and the second laser are mounted on opposite sides of the temperature measurement device creating a pyrometer assembly, and wherein the first laser beam is located near the first edge portion and the second laser beam is located near the second edge portion so that the first laser beam and the second laser beam contact the target depth creating the first laser beam distance and the second laser beam distance, and wherein the at least one sensor detects the first laser beam distance and the second laser beam distance, and wherein, if the at least one sensor detects a reduction in the first laser beam distance or the second laser beam distance, the sensor provides a signal to realign the pyrometer assembly so the at least one sensor detects a first laser beam distance to the target and a second laser beam distance to the target.

The structure, overall operation and technical characteristics of the present invention will become apparent with the detailed description of preferred embodiments and the illustration of the related drawings herein.

It is to be understood that both the foregoing general description and the following detailed description are exemplary and explanatory only and are intended to provide further explanation of the present invention, as claimed.

### BRIEF DESCRIPTION OF THE DRAWINGS

The disclosure is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1-2 show prior art from US Patent Publication No. 2016/0325353.

FIG. 3 illustrates a side view of an embodiment of the invention.

FIG. 4 illustrates a perspective view of part of the embodiment shown in FIG. 3.

FIG. 5 illustrates a simplified, schematic view of the embodiment of FIG. 3.

FIG. 6 illustrates a logic flow diagram for the embodiment of FIG. 3.

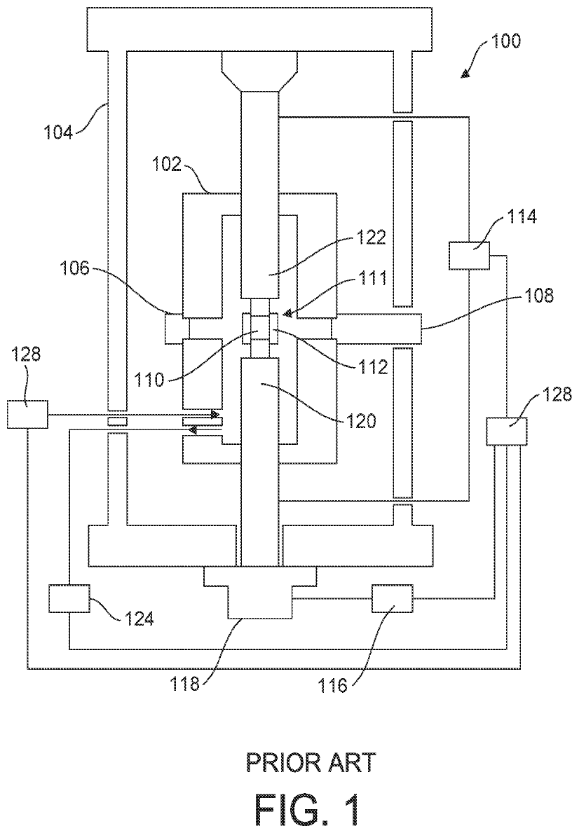

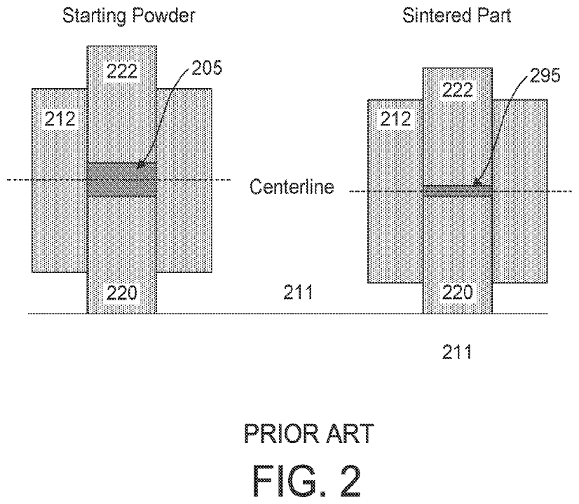

### DETAILED DESCRIPTION.

The present invention relates to a method and system/apparatus for sintering materials under compression.

In general, a compressive sintering process, such as hot pressing and spark plasma sintering (SPS) (SPS is also known as direct current sintering (DCS)), involves the use of pressure and high temperature to convert a material to be sintered, especially in particulate or powder (fine particulate) form to a higher density product. SPS is a pressure assisted direct current heated sintering process that utilizes uniaxial force and direct current to consolidate powder material. Specifically, DC voltage and current is applied to an electrically conductive die assembly (die set). Due to heat being generated within the die set and potentially within the powder, high heating rates are achievable, in contrast to conventional hot pressing where heat must be transferred into the die set from the exterior by radiant heating elements. During SPS sintering, heat is generated in and around the material in the die, rapidly heating the material and limiting particle/grain growth due to the speed of the process. The entire process—from powder to finished sintered sample—is completed faster, with high uniformity.

In an SPS process, it is believed that electrical current flowing between particles can assist in removing fine impurities and gases on and between the surfaces of the particles due to dielectric breakdown of surface oxides and local heating. In addition, the higher heating rates achievable allow fine powders to be heated to high temperatures before grain coarsening can occur, allowing the powder to retain a high surface area to contribute to the sintering process, which progresses more rapidly.

Force (pressure) also plays an important and predictable role in curbing particulate growth and influencing overall densities in SPS systems. For example, force multiplies diffusion throughout the sample as the material moves under pressure, especially during early sintering stages. Both too much and too little pressure can negatively influence the process. In large samples where high density is required, force is commonly increased in stages to enhance out-gassing at low temperature and sintering diffusion at higher temperatures. Accordingly, accurate manipulation of force can enhance the process.

For compression sintering systems, accurate determination of temperature is needed in order to monitor and control the process, thereby consistently producing sintered products with desired and predictable properties. As the material is consolidated and compressed, the temperature profile across the product changes. For example, the position of highest temperature across the material changes, and, as a result, the temperature measurement device, such as a pyrometer, must be repositioned during the sintering process in order to track and maintain monitoring of this position, in order to provide accurate process control. This is typically done manually, which is time consuming to do accurately, especially for sintering projects that require several hours. Thus, in the process and apparatus of the present invention, a control system is used to assess the relative position of the temperature measurement device to a target location of the die cavity of the die set, in which the control system causes the repositioning of the temperature measurement device, thereby maintaining a constant relative positioning.

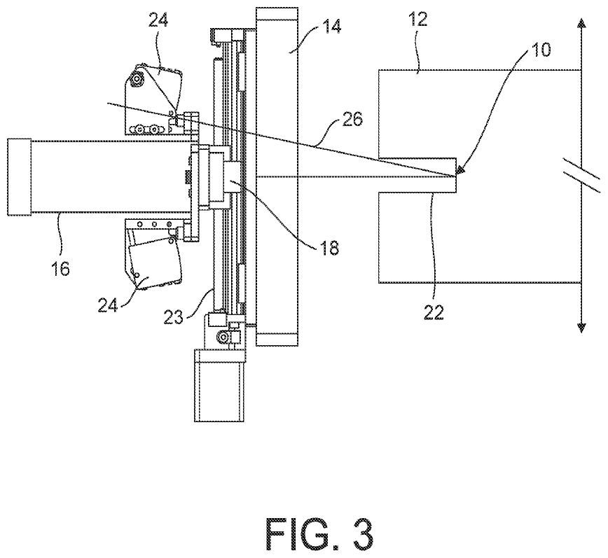

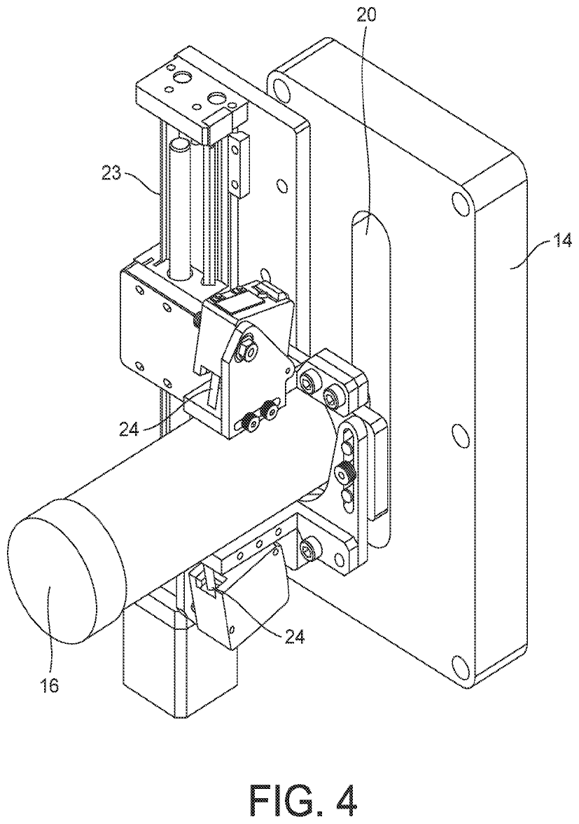

A specific example is shown in FIG. 3 and FIG. 4. However, it should be apparent to those skilled in the art that this is merely illustrative in nature and not limiting, being presented by way of example only. Numerous modifications and other embodiments are within the scope of one of ordinary skill in the art and are contemplated as falling within the scope of the present invention. In addition, those skilled in the art should appreciate that the specific conditions and configurations are exemplary and that actual conditions and configurations will depend on the specific system. Those skilled in the art will also be able to recognize and identify equivalents to the specific elements shown, using no more than routine experimentation.

In this example, a pyrometer is placed at a position relative to the die set to monitor the temperature of a target location of the die cavity, which is a recess in the outer wall of the die near the centerline of the die cavity. Once compressive sintering has begun, the position of the recess relative to the pyrometer is monitored and adjusted.

For example, a motorized stage can be used to reposition the pyrometer. This repositioning method can be repeated as often as needed throughout the compressive sintering process, either in steps (semi-continuously) or continuously. This automated process eliminates human error that occurs while adjusting the pyrometer position manually and improves process consistency by maintaining the same pyrometer position during each process cycle. In addition, the process and system, including a control system configured to move the temperature measurement device during sintering based on a real time measuring system.

As shown in FIG. 3, one embodiment of the invention is directed to a system for monitoring temperature of a location 10 on a die 12. FIG. 3 illustrates a portion of a side view of the die 12 in exaggerated form to facilitate description thereof. The die 12 is located in a chamber of an SPS machine for sintering a material (not shown) contained in the die 12. The SPS machine is of conventional type commercially available from suppliers such as Thermal Technology LLC of Minden, Nevada, USA.

The die 12 is surrounded by walls of the chamber, one wall 14 of which is shown in FIG. 3. The chamber walls, such as wall 14, enclose and insulate the interior of the chamber from the outside environment. Typically, the chamber is evacuated during sintering as the material composing the die will ignite and combust in the presence of oxygen at temperatures typically reached during the sintering process.

During the sintering process, the temperature is monitored to ensure proper temperatures are reached and maintained to sinter the material in the die. FIG. 3 illustrates a pyrometer 16 positioned for monitoring temperature at the aforementioned location 10 of the die 12. The pyrometer 16 is of conventional design, commercially available from suppliers such as Fluke Process Instruments of Everett, WA, USA.

The pyrometer 16 is a type of remote sensing thermometer that measures temperature based upon the intensity of thermal radiation received at one end 18 of the pyrometer 16. To enable the pyrometer 16 to receive thermal radiation emanating from the die 12, the chamber wall 14 includes a window 20 (see FIG. 4) made of material substantially transparent to thermal radiation and capable of withstanding high temperatures, such as quartz.

Referring to FIG. 4, the window 20 is elongated, having a height substantially greater than its width. The long height of the window 20 permits the position of the pyrometer 16 to be adjusted to opposite the location 10 of the die 12. In particular, the location 10 is at the bottom of a recess 22 formed in the side of the die 12. Due to being at the bottom or end of the recess 22, the location 10 is closer to the material being sintered than other locations along the side of the 10. Further, the recess 22 tends to direct thermal radiation outward along the central axis 23 of the recess 22. Hence, adjusting the end 18 of the pyrometer to be opposite the location 10 at the end of the recess 22 is the optimal position for most reliably and accurately measuring the temperature of the die 12, that is, facing towards the location 10 at the end of the recess 22 in the die 12, generally along the central axis of the recess.

The system for monitoring temperature at the location 10 at the end of the recess 22 includes first and second laser measuring devices 24 mounted to the pyrometer 16. One of the laser measuring devices 24 is mounted proximate one side of the pyrometer 16, and the other laser measuring device is mounted proximate the opposite side of the pyrometer. In operation, each laser measuring device 24 projects a laser beam 26 and measures distance from the laser measuring device to a location on which the laser beam is projected. For clarity of description, FIG. 3 shows only the upper laser measuring device 24 projecting a laser beam 26. In operation however, each laser measuring device 24 projects a laser beam. The laser measuring devices 24 are of conventional design and commercially available from suppliers such as Keyence Corporation of America in Itasca, IL, USA.

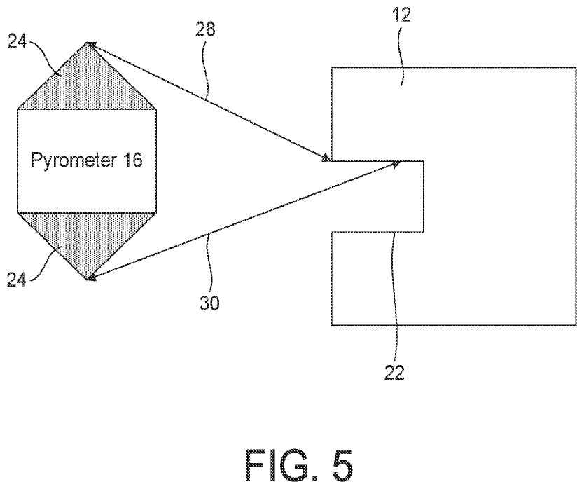

Each laser measuring device 24 projects a laser beam 26 and measures distance from the laser measuring device to a location on which the laser beam is projected. FIG. 3 illustrates the laser 26 projecting on to the location 10 at the end of the recess 22 in the side of the die 12. As will be appreciated however, if the pyrometer 16 was positioned slightly more upward along the chamber wall 14, the laser beam 26 would strike the outer sidewall of the die 12 and not project into the recess 22. The distance from each laser measuring device 24 to the outer sidewall of the die 12 is defined herein as the minimum distance 28 (see FIG. 5), and should be same or close to the same value for each laser measuring device 24.

Each laser measuring device 24 outputs a signal indicating whether the measured distance is less than or equal to a minimum distance 28; FIG. 5 schematically illustrates the minimum distance 28 with simplified geometric shapes for the monitoring system 12 and with the chamber wall 14 omitted. In FIG. 5, the pyrometer 16 is positioned higher relative to the recess 22 as compared to the pyrometer position in FIG. 4. Hence, the distance measured by the upper laser measuring device is the same as the minimum distance 28 (not greater), and the upper laser measuring device accordingly outputs a signal indicating that the measured distance is less than or equal to the minimum distance 28. In contrast, the lower measuring device 24 is at a position where its laser beam projects into the recess 22. Therefore, the lower measuring device 24 outputs a signal indicating that the measured distance is not less than or equal to the minimum distance. Alternatively stated, each laser measuring device is outputting a signal indicating whether its laser beam is projecting into the recess 22 or not. If the measured distance is less than or equal to the minimum distance, the laser beam is projecting onto the side of the die 12, and not into the recess 22.

In this regard, the laser measuring devices are programmable so that the minimum distance 28 may be adjusted to correspond to the SPS apparatus that the temperature monitoring system is being used with. For example, if a particular SPS apparatus is larger and has a thicker chamber wall 14, the minimum distance 28 may be programmed to a larger value. In addition, the signals may be modified to output a signal indicating that the measured distance is greater than the minimum distance 28. Alternatively, the signals could output measurement distances rather than binary signals.

Returning to FIG. 3, the temperature monitoring system includes an actuator 32 connected in communication with each laser measuring device 24 and receiving the signal output from each laser measuring device. The actuator 32 supports the pyrometer 16 and moves the pyrometer in first and second directions opposite one another in accordance with the signals received from the laser measuring devices until each received signal indicates the measured distance is not less than or equal to the minimum distance. The actuator is of conventional type including a stepper motor with an on-board programmable motion controller and drive electronics. Such actuators include those marketed under the trademark MDRIVE, available from Schneider Electric of Andover, Massachusetts, USA.

Initially, the position of the pyrometer is adjusted manually by an operator to position the pyrometer opposite the recess 22. At this position, the laser beam 26 from each device 24 projects into the recess 22 of the die 12 and the temperature monitor system is initiated. As the material in the device 12 sinters, the die 12 moves up and down, as does the recess 22 because the recess is formed integrally with the die. If either laser measuring device 24 measures a distance that is less than or equal to the minimum distance 28, the laser measuring device outputs a signal to the actuator 23. The actuator 23 moves the pyrometer 16 in accordance with the signal received. If the signal received is from the upper laser measuring device 24, the actuator 23 moves the pyrometer downward until there is no longer a signal from the upper laser measuring device indicating a measurement distance less than or equal to the minimum distance 28.

Conversely, if the actuator receives a signal from the second measuring device 24 (lower measuring device), the actuator 23 moves the pyrometer 16 upward until the signal is no longer received. If the actuator 23 removes signals from both laser measuring devices 24, this indicates an error condition requiring intervention from an operator to manually reposition the pyrometer 16. In the event of an error condition, the actuator 23 does not move the pyrometer 16 in either direction.

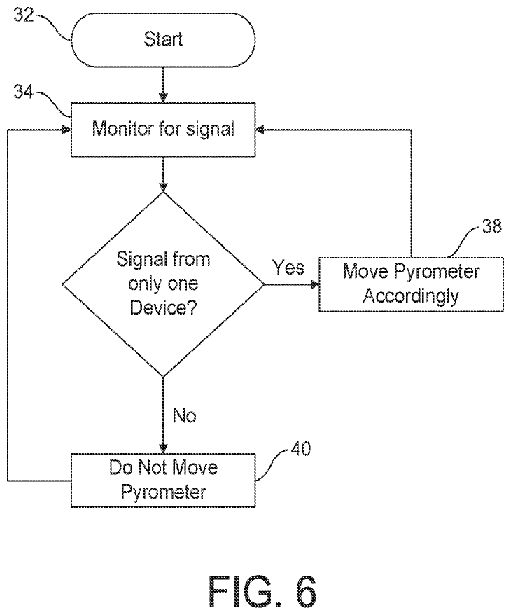

FIG. 6 illustrates a flow chart of the logic for the temperature monitoring system. The system starts with block 32 after an operator has positioned the pyrometer 16 opposite the recess 22 in which no signal from a laser measuring device 24 is being received that is indicative of a measured distance being less than or equal to a minimum distance. The logic thereafter proceeds to block 34, whereupon the actuator 23 monitors for receipt of a signal. If a signal is received, the logic determines in block 36 if the signal is being received from only one of the laser measuring devices 24 indicating that the measured distance is less than the minimum distance 28. If the determination is in the affirmative, the actuator 23 moves the pyrometer in accordance with the signal received in block 38. Specifically, if the signal is from the upper laser measuring device 24, the upper laser device 24 is too high and the actuator 23 moves the pyrometer 16 downward. If the signal is from the lower measuring device 24, the lower laser measuring device 24 is too low and the actuator 23 moves the pyrometer 16 upward. As the laser measuring devices are mounted to the pyrometer 16, the laser measuring devices 24 move with the pyrometer 16.

If the determination is negative in block 36, the logic flow proceeds to block 40, in which the actuator 23 takes no action, that is, the pyrometer 16 is not moved and the logic thereafter returns to monitor for a signal in block 34.

For convenience of explanation, the terms upper and lower have been used in the foregoing description to distinguish the laser measuring devices 24 from one another. However, the terms first and second or one and the other could also be used and are defined herein to be synonymous with upper and lower. In this regard, some sintering devices are not arranged vertically and may have other orientations rather than upper and lower.

When the laser measuring devices 24 are not outputting a signal indicating the measured distance is less than or equal to a minimum distance, the end of pyrometer is positioned opposite the location 10 in the recess 22 of the die 12 for receiving thermal radiation therefrom and outputting a temperature signal based on the intensity of the thermal radiation received.

The foregoing description of preferred embodiments of the present invention has been presented for the purposes of illustration and description. It is not intended to be exhaustive or to limit the invention to the precise form disclosed. Modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A system for monitoring temperature of a location on a die, the system comprising:
a pyrometer having an end, the pyrometer being configured to measure temperature based upon intensity of thermal radiation received at the end of the pyrometer, the pyrometer having opposite sides;
first and second laser measuring devices mounted to the pyrometer, one of the laser measuring devices being mounted proximate one side of the pyrometer, and the other laser measuring device being mounted proximate the opposite side of the pyrometer, each laser measuring device projecting a laser beam and measuring distance from the laser measuring device to a location on which the laser beam is projected, each laser measuring device outputting a signal indicating whether the measured distance is less than or equal to a minimum distance; and
an actuator connected in communication with each laser measuring device and receiving the signal output from each laser measuring device, the actuator supporting the pyrometer and moving the pyrometer in first and second directions opposite one another in accordance with the signals received from the laser measuring devices until each received signal indicates the measured distance is not less than or equal to the minimum distance ;
wherein when each received signal indicates the measured distance is greater than the minimum distance, the end of the pyrometer is positioned opposite the location on the die for receiving thermal radiation therefrom and outputting a temperature signal based on the intensity of the thermal radiation.

2. The system of claim 1, wherein the actuator moves the pyrometer up and down and the pyrometer includes a top and a bottom with one of the laser measuring devices mounted proximate the top of the pyrometer and the other laser measuring device is mounted proximate the bottom of the die, and when the actuator receives a signal from said one of the laser measuring devices, the actuator moves the pyrometer downward, and when the actuator receives a signal from said other laser measuring device, the actuator moves the pyrometer upward.

3. The system of claim 1, wherein the actuator receives a signal from both the laser measuring devices, the actuator does not adjust the position of the pyrometer.

4. The system of claim 1, wherein the die includes a height and the actuator moves the pyrometer parallel to the height of the die.

5. The system of claim 1, wherein the laser measuring devices are aligned vertically along the height of the die.

6. The system of claim 1, wherein each laser measuring device is mounted an equal distance from the die in which the distance is measured from a point on the outer sidewall of the die closest to the laser measuring device.

7. The system of claim 1, wherein the actuator is programmable.

8. A method of tracking of a recess in a die using a temperature measurement device, the method comprising the steps of:
mounting oppositely a first laser and a second laser to a temperature measurement device to create a pyrometer assembly;
aligning the temperature measurement device with the recess using the first laser to project a laser beam into the recess to measure a first laser beam distance and project the second laser beam into the recess to measure a second laser beam distance; and
realigning the temperature measurement device with the recess by moving the pyrometer assembly when a reduction of the first laser beam distance or the second laser beam distance is detected so that the first laser beam and the second laser beam are projected into the recess.

9. The method of claim 8, wherein the die includes a height and said step of mounting includes mounting the first laser and second laser oppositely along the height of the die.

10. The method of Claim wherein when a reduction of the first laser beam distance is detected, the pyrometer assembly is moved in a first direction, and when a reduction of the second laser beam distance is detected, the pyrometer assembly is moved in a second direction opposite the first direction.

11. The method of claim 8, where each laser is integrated with a laser measurement device, which detects when there is a reduction in laser beam distance and provides a signal.

12. The method of claim 11, further comprising the step of mounting the pyrometer assembly to an actuator receiving the signals with the actuator, and performing the step of realigning by using the actuator to move the pyrometer assembly in accordance with the signal received.

13. The method of claim 8, further comprising the step of mounting the pyrometer assembly to an actuator and using the actuator to perform the steps of aligning and realigning.

14. The method of claim 8, wherein the step of mounting, includes mounting the lasers equally distant from a point on the die nearest each laser.

15. A method of forming a sintered product comprising, in any order, the steps:
i) loading a material to be sintered into a die cavity of a die set comprising a casing and opposing rams configured to compress the material;
ii) placing the die set into a vacuum chamber of a sintering apparatus, the sintering apparatus comprising a temperature measurement device configured to determine the temperature of material in the die cavity during sintering and a control system configured to move the temperature measurement device during sintering;
iii) positioning the temperature measurement device relative to a target location of the die cavity using a first laser and a second laser to a temperature measurement device to create a pyrometer assembly, aligning the temperature measurement device with the die cavity using the first laser to project a laser beam into the die cavity to create a first laser beam distance and the second laser beam to project into the die cavity to create a second laser beam distance, realigning the temperature measurement device with die cavity automatically by moving the pyrometer assembly when a reduction of the first laser beam distance or the second laser beam distance is detected so that the first laser beam and the second laser beam are projected into the die cavity, and
iv) compressively sintering the material in the die cavity to form the sintered product, wherein, during the compressive sintering, the temperature measurement device is moved in order to maintain the relative positioning to the target location of the die cavity using the control system.

16. The method of claim 15, wherein the sintering apparatus further comprises a repositioning device in communication with the temperature measurement device and the control system, and wherein the temperature measurement device is moved by the repositioning device using the control system.

17. The method of claim 15, wherein the die set comprises an outer casing, an upper ram, and a lower ram, and wherein the step of moving the temperature measurement device comprises determining a position of the upper ram, the lower ram, or both.

18. The method of claim 15, wherein the temperature measurement device is moved continuously during the compressive sintering.

19. The method of claim 15, wherein moving the temperature measurement device is automated.

20. The method of claim 15, wherein the sintering apparatus is a spark plasma sintering apparatus or a direct current sintering apparatus.
